(19) United States
(12) Patent Application Publication
(10) Pub. No.: US 2021/0061265 A1
(43) Pub. Date: Mar. 4, 2021

(54) SYSTEMS AND METHODS FOR INHIBITING REAR COLLISIONS

(71) Applicant: Indiev, Inc, Los Angeles, CA (US)

(72) Inventor: Diego Furtado, Los Angeles, CA (US)

(21) Appl. No.: 16/556,367

(22) Filed: Aug. 30, 2019

(51) Int. Cl. B60W 30/085; B60R 21/0132; B60Q 9/00

(52) U.S. Cl. CPC B60W 30/085; B60R 21/0132; B60R 2021/01013; B60R 2021/01322; B60Q 9/008

(57) ABSTRACT

Methods and systems for deterring rear collisions and/or mitigating the damage caused therefrom are provided. When the host vehicle is slowing down, coming to a stop, or stopped, and the system senses that an external vehicle in the rear is approaching at an unsafe speed, an external warning system can be activated to attempt to gain the attention of the driver of the external vehicle. If the external vehicle continues to approach at an unsafe speed such that a collision seems likely or inevitable, a brace sequence within the host vehicle can be activated to reduce injury to occupants of the host vehicle.

### BACKGROUND

Operating a motor vehicle remains one of the more dangerous modes of transportation in modern society. With the prevalence of portable electronics such as smart phones, distracted drivers are becoming more common all the time. As such, it is important for a driver to remain aware of his or her surroundings when operating a motor vehicle. Advanced Driver Assistance Systems (ADAS) have been able to reduce the risk of injury and vehicle damage by assisting drivers with warnings and active controls. However, risk of collisions caused by other drivers continues to be a legitimate concern for all drivers.

### BRIEF SUMMARY

Embodiments of the subject invention provide novel and advantageous methods and systems for deterring rear collisions and/or mitigating the damage caused therefrom. While traditional ADASs all work to assist the driver of the host vehicle equipped with the system, embodiments of the subject invention can warn a driver of an external vehicle who may be approaching at an unsafe speed from behind a host vehicle that is braking or stopped. This can help inhibit or prevent a rear-end collision by alerting an inattentive driver of an external vehicle approaching from the rear. When the driver of the host vehicle is slowing down, coming to a stop, or stopped, and the system senses that an external vehicle in the rear is approaching at an unsafe speed, an external warning system can be activated to attempt to gain the attention of the driver of the external vehicle. If the external vehicle continues to approach at an unsafe speed such that a collision seems likely or inevitable, a brace sequence (or “brace for impact” sequence) within the host vehicle can be activated to reduce injury to occupants (e.g., the driver and any passengers that may be present) of the host vehicle.

In an embodiment, a method for inhibiting rear collisions of a host vehicle can comprise: i) monitoring, by at least one sensor of the host vehicle, a rear zone behind the host vehicle; ii) if an external vehicle is present in the rear zone, calculating, by a processor of the vehicle, a time-to-collision (TTC) of the external vehicle; and iii) if the TTC of the external vehicle is lower than a first predetermined threshold, activating an external warning system. The external warning system comprises flashing lights on a rear exterior portion of the host vehicle. The method can further comprise activating a brace sequence of the host vehicle if the TTC of the external vehicle is lower than a second predetermined threshold, which is lower than the first predetermined threshold.

### BRIEF DESCRIPTION OF DRAWINGS

FIG. 1 shows a block diagram of elements of a rear collision deterrent system of a vehicle, according to an embodiment of the subject invention.

FIG. 2 shows a flow diagram of an algorithm for a rear collision deterrent system of a vehicle, according to an embodiment of the subject invention.

FIG. 3 shows a schematic diagram of a rear zone of a vehicle, according to an embodiment of the subject invention.

### DETAILED DESCRIPTION

Embodiments of the subject invention provide novel and advantageous methods and systems for deterring rear collisions and/or mitigating the damage caused therefrom. Embodiments of the subject invention can warn a driver of an external vehicle who may be approaching at an unsafe speed from behind a host vehicle that is braking or stopped. This can help inhibit or prevent a rear-end collision by alerting an inattentive driver of an external vehicle approaching from the rear. When the driver of the host vehicle is slowing down, coming to a stop, or stopped, and the system senses that an external vehicle in the rear is approaching at an unsafe speed, an external warning system can be activated to attempt to gain the attention of the driver of the external vehicle. If the external vehicle continues to approach at an unsafe speed such that a collision seems likely or inevitable, a brace sequence (or “brace for impact” sequence) within the host vehicle can be activated to reduce injury to occupants (e.g., the driver and any passengers that may be present) of the host vehicle.

The systems and methods of embodiments of the subject invention do not require any active involvement on the part of the driver of the host vehicle. As long as the system/method has not been specifically deactivated, the driver of the host vehicle drives as normal and the system operates passively. The system utilizes one or more sensors of the host vehicle (e.g., rear radar(s), rear-facing camera(s), lidar) to scan a rear zone behind the host vehicle. If there is no external vehicle present in the rear zone, nothing unusual happens and the driver continues driving as normal. If there is an external vehicle present in the rear zone and the host vehicle indicates it is braking, sensors provide data about the external vehicle in the rear zone. If the system determines that the external vehicle presents a threat of a rear collision based on its speed, position, and/or acceleration (possibly along with other factors) in relation to a threshold, the system will attempt to warn the driver in the external vehicle that their approach speed is too fast, in the hopes that the external vehicle driver will begin braking. The speed, position, and/or acceleration of the external vehicle (possibly along with other factors) will continue to be monitored and if the external vehicle reduces its speed sufficiently or exits the rear zone, the external warning system is deactivated; otherwise, if the threat of a rear collision escalates past another threshold, a brace sequence can be initiated to attempt to mitigate damage to from a potential rear-end collision from the external vehicle.

The vehicle, which can be referred to as the host vehicle to distinguish from external vehicles that may be in the monitored rear zone, can include processor that can run one or more algorithms to determine whether to activate or deactivate an external warning system and/or brace sequence of the host vehicle. The processor can be part of a computer (e.g., a vehicle-integrated computer) of the host vehicle and/or can be part of a system of the host vehicle (e.g., an infotainment system or other system). The host vehicle can include multiple processors, and any or all can be used to run one or more algorithms to determine whether to activate or deactivate an external warning system and/or brace sequence of the host vehicle. The one or more algorithms can be stored as (or on) software or code, which can be stored on one or more (non-transitory) machine-readable media (e.g., (non-transitory) computer-readable media) that can be in operable communication with the processor(s). A user or driver of the host vehicle can activate or deactivate, as desired, the rear collision deterrent system by interacting with the host vehicle (e.g., by selecting an option on an infotainment system or other system of the vehicle). The vehicle can be any suitable type of roadworthy vehicle (e.g., a car, truck, motorcycle). The vehicle can be an electric vehicle, though embodiments are not limited thereto.

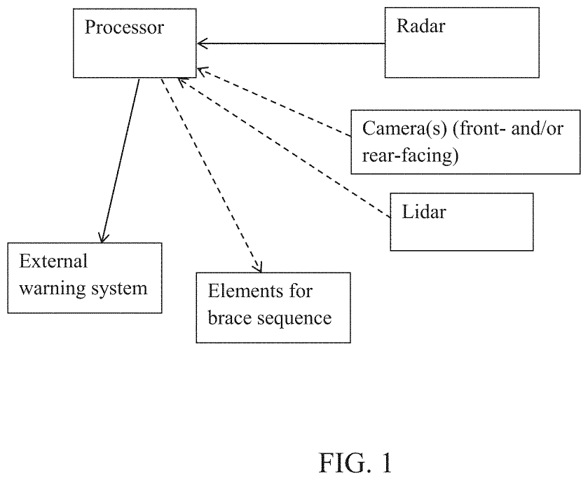

FIG. 1 shows a block diagram of elements of a rear collision deterrent system of a vehicle, according to an embodiment of the subject invention. Referring to FIG. 1, the system can include a processor, radar (radio detection and ranging), and an external warning system. The radar sends to the processor information about the rear zone of the host vehicle, and the processor can activate or deactivate the external warning system based on certain conditions, which are described in detail herein. The system can optionally further include lidar (light detection and ranging), at least one rear-facing camera, at least one front-facing camera, and/or elements for a brace sequence. The lidar (if present), at least one rear-facing camera (if present) can send to the processor information about the rear zone of the host vehicle, and the at least one front-facing camera (if present) can send to the processor information about the front of the vehicle and/or information about the width of the lane in which the host vehicle is driving, the latter of which can be used to determine or help determine a width of the rear zone. The processor can activate or deactivate the brace sequence based on certain conditions, which are described in detail herein. The radar can monitor the rear zone of the host vehicle to determine if any external vehicles are present therein and, if so, what the speed and/or acceleration of the external vehicle is. Lidar (if present) can be used for redundancy of the radar (i.e., to perform the same tasks as the radar to increase accuracy, reliability, and/or detection range). The rear-facing camera(s) (if present) can also be used for redundancy of the radar (and lidar, if present), to gather information about the width of the lane in which the host vehicle is driving (either as a redundancy to the front-facing camera(s) (if present) or as a sole source of this information), and/or to gather external vehicle information such as vehicle size and/or vehicle class (information that can be used to adjust the relevant thresholds).

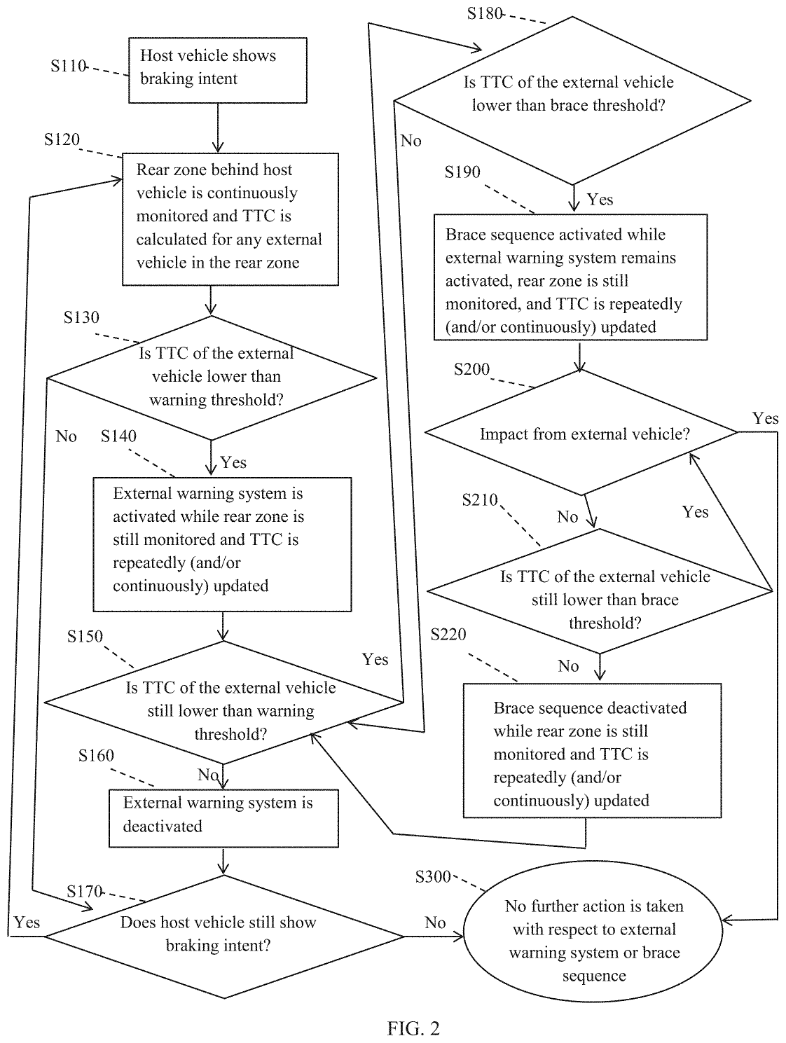

FIG. 2 shows a flow diagram of an algorithm for a rear collision deterrent system of a vehicle, according to an embodiment of the subject invention. Referring to FIG. 2, the algorithm starts when the host vehicle shows braking intent (step S110), and this is done by the user (i.e., driver) of the host vehicle pressing the brake pedal and/or utilizing any other brake in the vehicle (e.g., emergency brake or regenerative braking actuators) while the vehicle is in use. The showing of braking intent can require that the brake is engaged, or it can be considered enough that the vehicle is on and parked. The rear zone behind the host vehicles is continuously monitored (step S120) by sensor(s), which can include radar (and/or other elements if present (e.g., lidar, rear-facing camera(s)) and, if external vehicle is detected in the rear zone, its speed, acceleration, and/or distance from the host vehicle is determined by the sensor(s). An estimate of the time-to-collision (TTC) between the external vehicle and the host vehicle is then calculated (e.g., by the processor(s) of the vehicle). The TTC is based on the speed of the external vehicle, acceleration of the external vehicle, and/or distance between the host vehicle and the external vehicle. The current speed and deceleration of the host vehicle can also be taken into account for the TTC estimate.

The system then determines whether the TTC of the external vehicle is lower than a first predetermined threshold, which can be referred to as a warning threshold (step S130). If the TTC is lower than the warning threshold, the external warning system is activated to attempt to gain the attention of the driver or other occupant of the external vehicle (step S140) while the rear zone will continue to be monitored and the TTC is repeatedly calculated (e.g., the TTC can be continuously updated) based on the updated information about the external vehicle received from the sensor(s). The external warning system can include flashing lights on the exterior (e.g., rear) of the host vehicle, and the flashing lights can be, for example, brake lights, turn signal lights, dedicated rear collision deterrent system lights, any other lights that may be on the exterior (e.g., rear) of the vehicle, or any combination thereof. The external warning system can also include an audible component, which could include activating the horn sound and/or another available exterior sound of the host vehicle. For example, activation of the external warning system can include flashing the brake lights and turn signals on the rear of the host vehicle (possibly in combination with the horn sound being activated). If the TTC of the external vehicle is not lower than the warning threshold, then the system will check whether the host vehicle still shows braking intent (step S170) (e.g., is a brake still activated in the vehicle) and, if so, the algorithm goes back to step S120 where the rear zone continues to be monitored. If the host vehicle no longer shows braking intent in step S170, then the algorithm ends and no further action is taken with respect to the external warning system or brace sequence (S300).

If the external warning system was activated (S140), the system continues to check whether the TTC is still lower than the warning threshold (step S150). If the TTC is no longer lower than the warning threshold, the external warning system is deactivated (S160) and the algorithm proceeds to step S170, which has already been discussed. If the TTC is still lower than the warning threshold in step S150, then the system determines whether the TTC of the external vehicle is lower than a second predetermined threshold, which can be referred to as a brace threshold (step S180). If the TTC is lower than the brace threshold, the brace sequence of the host vehicle is activated (step S190), to brace for possible impact from the external vehicle, while the external warning system remains activated, the rear zone continues to be monitored, and the TTC is repeatedly calculated (e.g., the TTC can be continuously updated) based on the updated information about the external vehicle received from the sensor(s). The brace sequence, or “brace for impact” sequence, can include, but is not necessarily limited to, at least one of the following: pre-tension the seatbelts in the host vehicle; ready the airbags in the host vehicle; tilt the head rest(s) forward in the host vehicle; move the seats (e.g., to an optimal position for air bags, which may depend on size of person, specifications of the host vehicle itself, and/or the person's position within the host vehicle); tilt the suspension of the host vehicle (e.g., raise the back of the host vehicle); and accelerate the host vehicle. If the TTC of the external vehicle is not lower than the brace threshold in step S180, then the algorithm proceeds back to step S150, which has already been discussed.

If the brace sequence was activated (S190), impact from the external vehicle (S200) will end the algorithm (S300), and if there is no impact the system continues to check whether the TTC is still lower than the brace threshold (step S210). If the TTC is no longer lower than the brace threshold, the brace sequence is deactivated (S220) while the rear zone is still monitored and the TTC is repeatedly (and/or continuously) updated, and the algorithm proceeds back to step S150, which has already been discussed. If the TTC is still lower than the brace threshold in step S210, then the system will stay on steps S200 and S210 until the TTC increases to the brace threshold or higher, there is impact from the external vehicle, or the external vehicle exits the rear zone.

It is noted that, though not depicted in FIG. 2, if no external vehicle is detected in the rear zone during step S120, then the algorithm goes to step S170, and if no external vehicle is detected in the rear zone at all before the host vehicle no longer shows braking intent, then the algorithm ends (S300) without ever calculating a TTC or reaching step S130. Also, though not depicted in FIG. 2, if an external vehicle is detected in the rear zone in step S120, and that external vehicle exits the rear zone (e.g., by switching to a different lane or braking more quickly than the host vehicle such that its position extends beyond the length of the rear zone), then the algorithm goes to step S170 (the brace sequence will be deactivated if it has been activated and the external warning system will be deactivated if it has been activated).

In an embodiment, the brace for impact sequence can include accelerating the host vehicle forward, which requires that the processor have knowledge of the environment in front of the vehicle. If the external warning sequence has been activated (S140), the system can monitor the front of the vehicle for pedestrians, bicyclists, animals, stopped external vehicles, moving external vehicles, crossing external vehicles, or other objects by using sensor data of the host vehicle. Such sensor data can include data from at least one front camera, lidar, front radar, corner radars, and/or ultrasonic sensors. Once the brace for impact sequence has been activated, the system can know how much room the host vehicle has available to move forward without causing a front collision with any external object and can attempt to accelerate forward once the system has determined that, based on the TTC and the TTC rate of change, a rear collision would otherwise be imminent.

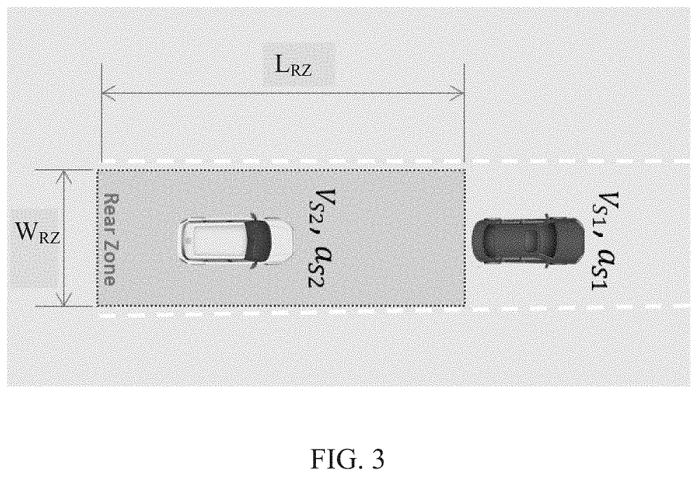

FIG. 3 shows a schematic diagram of a rear zone of the host vehicle (right side of FIG. 3), according to an embodiment of the subject invention. Referring to FIG. 3, the rear zone has a width (W_{RZ}) and a length (L_{RZ}), with the length being a certain distance behind the host vehicle. The rear zone moves together with the host vehicle. The width of the rear zone can be defined multiple different ways, including but not necessarily limited to: a width of the lane in which the host vehicle is traveling; a center point of the lane in which the host vehicle is traveling plus a certain distance on either side thereof (e.g., the certain distance can be half the average lane width in the United States or in a region in which the vehicle is located according to vehicle GPS data, or 90% of such value); or a certain distance on either side of a center point of the rear of the host vehicle (e.g., the certain distance can be half the average lane width in the United States or in a region in which the vehicle is located according to vehicle GPS data, or 90% of such value). The length of the rear zone can be a predetermined distance behind the host vehicle and may be limited by the sensor(s) of the host vehicle. For example, if radar of the host vehicle only has a range of 200 meters, then the length of the rear zone may be limited to 200 meters.

Table 1 shows reaction distance, braking distance, and total stopping distance (reaction distance+braking distance) for different speeds, based on average reaction time, expected braking distances, and dry road conditions. All speeds are shown in kilometers per hour (kph), and all distances are shown in meters (m). During braking, the average reduction in velocity is about 4.6 meters per second per second (m/s²) (about 15 feet per second per second (ft/s²)), with very little relevance on the initial velocity of the vehicle stopping. This information can be used when determining the TTC. By way of example, if it is assumed that an external vehicle is approaching a stopped host vehicle at 160 kph, which is about 100 miles per hour (mph), it would take such an external vehicle approximately 9.8 seconds to completely stop, so 9.8 seconds could be the calculated TTC estimate in this situation.

TABLE 1
Vehicle stopping distances at various speeds

| | Reaction | Braking | Total |
|---|---|---|---|
| Speed (kph) | Distance (m) | Distrance (m) | Distance (m) |
| 30.0 | 12.5 | 5.3 | 17.8 |
| 40.0 | 16.7 | 9.4 | 26.1 |
| 50.0 | 20.8 | 14.7 | 35.5 |
| 60.0 | 25.0 | 21.2 | 46.2 |
| 70.0 | 29.2 | 28.8 | 58.0 |
| 80.0 | 33.3 | 37.6 | 71.0 |
| 90.0 | 37.5 | 47.6 | 85.1 |
| 100.0 | 41.7 | 58.8 | 100.5 |
| 110.0 | 45.8 | 71.2 | 117.0 |
| 120.0 | 50.0 | 84.7 | 134.7 |
| 130.0 | 54.2 | 99.4 | 153.6 |
| 140.0 | 58.3 | 115.3 | 173.6 |
| 150.0 | 62.5 | 132.4 | 194.9 |
| 160.0 | 66.7 | 150.6 | 217.3 |

The TTC warning threshold can be, for example, any of the following values, at least any of the following values, about any of the following values, no more than any of the following values, or within any range having any of the following values as endpoints (all values are in seconds): 2, 3, 4, 5, 6, 7, 8, 9, 10, 11, 12, 13, 14, 15, 16, 17, 18, 19, 20, 21, 22, 23, 24, or 25. For example, the warning threshold can be 13 seconds. The TTC brace threshold can be, for example, any of the following values, at least any of the following values, about any of the following values, no more than any of the following values, or within any range having any of the following values as endpoints (all values are in seconds): 0.5, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 5, 6, 7, 8, 9, 10, 11, 12, 13, 14, or 15. For example, the warning threshold can be 2 seconds.

In many embodiments, the warning threshold and/or brace threshold can be increased when it is raining out. The system can determine that it is raining out from a rain sensor of the host vehicle and/or by checking continuous use of the windshield wipers. If the system determines that it is raining out, the TTC warning threshold can be such that a driver of an approaching external vehicle can be warned earlier when it is raining outside, providing extra stopping time and distance. The brace threshold can also be increased if it raining outside.

In many embodiments, the warning threshold and/or brace threshold can be increased when traveling on a low-friction road. The system can determine that the vehicle is traveling on a low-friction road from powertrain, braking system, and/or sensors of the host vehicle. If the system determines that the host vehicle is traveling on a low-friction road, the TTC warning threshold can be such that a driver of an approaching external vehicle can be warned earlier, providing extra stopping time and distance. The brace threshold can also be increased if it is detected that the host vehicle is traveling on a low-friction road.

The width of the rear zone can be, for example, any of the following values, at least any of the following values, about any of the following values, no more than any of the following values, or within any range having any of the following values as endpoints (all values are in meters): 1, 1.5, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, or 7. For example, the width of the rear zone can be in a range of from 2.7 meters to 4.6 meters. As discussed herein, the width of the rear zone can also be determined dynamically based on information about the host vehicle and/or the lane in which it is traveling. The length of the rear zone can be, for example, any of the following values, at least any of the following values, about any of the following values, no more than any of the following values, or within any range having any of the following values as endpoints (all values are in meters): 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, or 350. For example, the width of the rear zone can be at least 150 meters, 200 meters, 250 meters, or 300 meters.

In certain embodiments, the brace sequence is only activated if the TTC of the external vehicle is less than the brace threshold and the TTC is also decreasing at a rate such that avoidance of the collision is unlikely or impossible. The deceleration rate of the approaching external vehicle has a finite upper limit, so based on the current speed of the external vehicle (along with speed and deceleration rate of the host vehicle if it is moving), an expected upper limit for the deceleration rate of the approaching external vehicle (e.g., 15 ft/s²) can be used to calculate the point at which avoidance of the collision is impossible based on the expected upper limit for the external vehicle deceleration rate. In these embodiments, the brace sequence is not activated until the TTC is less than the brace threshold and this point is reached (i.e., the point at which avoidance of the collision is impossible based on the expected upper limit for the external vehicle deceleration rate is reached).

In many embodiments, the external warning system includes flashing lights on the exterior (e.g., rear) of the host vehicle. Flashing lights have been proven to attract the attention of approaching drivers in Formula 1 racing, motorcycles, and other vehicles using a flashing light scheme to convey braking pressure. The external warning system can include providing a sequence of flashing lights to attract the attention of distracted drivers approaching from the rear. Systems and method of embodiments of the subject invention can help avoid collisions and, if a collision does occur, provide a mitigating effect on damage and injury to the occupants of both the host vehicle and the external vehicle.

While traditional ADAS features provide another layer of safety for the drivers of the vehicles equipped with such systems, embodiments of the subject invention provide functionality that other ADAS features fail to provide, which is the ability to warn other drivers of a possible or imminent collision. It does not matter if external vehicle drivers have systems or methods of embodiments of the subject invention, or even other ADAS features, installed on their vehicle. The other drivers will still be warned by systems and methods of embodiments of the subject invention. There are no related art ADAS features that assist drivers of external vehicles.

The methods, systems, and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals (i.e., computer-readable media can be referred to as non-transitory). A computer-readable medium of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

The subject invention includes, but is not limited to, the following exemplified embodiments.

Embodiment 1. A method for inhibiting rear collisions of a host vehicle, the method comprising:

i) monitoring, by at least one sensor of the host vehicle, a rear zone behind the host vehicle and determining, by a processor of the vehicle, whether an external vehicle is present in the rear zone;

ii) if an external vehicle is present in the rear zone, calculating, by the processor of the vehicle, a time-to-collision (TTC) of the external vehicle; and

iii) if the TTC of the external vehicle is lower than a first predetermined threshold, activating an external warning system, wherein the external warning system comprises flashing lights on a rear exterior portion of the host vehicle.

Embodiment 2. The method according to embodiment 1, further comprising:

iv) if the TTC of the external vehicle is lower than a second predetermined threshold, which is lower than the first predetermined threshold, activating a brace sequence of the host vehicle.

Embodiment 3. The method according to embodiment 1, further comprising:

iv) if the TTC of the external vehicle is lower than a second predetermined threshold, and the TTC of the external vehicle is decreasing at a rate such that a collision with the external vehicle is determined to be unavoidable, activating a brace sequence of the host vehicle.

Embodiment 4. The method according to any of embodiments 2-3, wherein the brace sequence is activated by the processor.

Embodiment 5. The method according to any of embodiments 2-4, wherein the brace sequence comprises: pre-tensioning seatbelts in the host vehicle; readying airbags in the host vehicle; tilting at least one head rest forward in the host vehicle; moving at least one seat (e.g., to an optimal position for air bags) in the host vehicle; tilting a suspension of the host vehicle to raise a back portion of the host vehicle; and/or accelerating the host vehicle forward.

Embodiment 6. The method according to any of embodiments 2-5, wherein the brace sequence is deactivated if the TTC of the external vehicle increases to the second predetermined threshold or higher.

Embodiment 7. The method according to embodiment 1, wherein the at least one sensor continues to monitor the rear zone and the processor continuously updates the TTC of the external vehicle after the brace sequence is deactivated.

Embodiment 8. The method according to any of embodiments 1-7, wherein the external warning system is deactivated if the TTC of the external vehicle increases to the first predetermined threshold or higher.

Embodiment 9. The method according to any of embodiments 1-8, further comprising, before step i):

determining if the host vehicle shows braking intent by engaging a brake of the host vehicle or shifting to park.

Embodiment 10. The method according to embodiment 9, wherein, if the external warning system is deactivated, the processor checks whether the host vehicle still shows braking intent and:

if so, the at least one sensor continues to monitor the rear zone; and

if not, the at least one sensor no longer monitors the rear zone.

Embodiment 11. The method according to any of embodiments 1-10, wherein the at least one sensor comprises a rear-facing radar sensor.

Embodiment 12. The method according to any of embodiments 1-11, wherein the at least one sensor comprises a rear-facing camera.

Embodiment 13. The method according to any of embodiments 1-12, wherein the at least one sensor comprises a front-facing camera.

Embodiment 14. The method according to any of embodiments 1-13, wherein the at least one sensor comprises a rear-facing lidar sensor.

Embodiment 15. The method according to any of embodiments 1-14, wherein a width of the rear zone is equal to a width of a lane in which the host vehicle is traveling.

Embodiment 16. The method according to any of embodiments 1-14, wherein a width of the rear zone is a predetermined distance on either side of a center point of a lane in which the host vehicle is traveling.

Embodiment 17. The method according to any of embodiments 1-14, wherein a width of the rear zone is a predetermined distance on either side of a center point of the rear exterior portion of the vehicle.

Embodiment 18. The method according to any of embodiments 16-17, wherein the predetermined distance is half of an average lane width in the United States of America.

Embodiment 19. The method according to any of embodiments 16-17, wherein the predetermined distance is 90% of half of an average lane width in the United States of America.

Embodiment 20. The method according to any of embodiments 16-17, wherein the predetermined distance is half of an average lane width in a region in which the host vehicle is traveling.

Embodiment 21. The method according to any of embodiments 16-17, wherein the predetermined distance is 90% of half of an average lane width in a region in which the host vehicle is traveling.

Embodiment 22. The method according to any of embodiments 1-21, wherein a length of the rear zone is at least 100 meters.

Embodiment 23. The method according to any of embodiments 1-21, wherein a length of the rear zone is at least 150 meters.

Embodiment 24. The method according to any of embodiments 1-21, wherein a length of the rear zone is at least 200 meters.

Embodiment 25. The method according to any of embodiments 1-21, wherein a length of the rear zone is at least 250 meters.

Embodiment 26. The method according to any of embodiments 1-21, wherein a length of the rear zone is at least 300 meters.

Embodiment 27. The method according to any of embodiments 1-26, wherein the flashing lights of the external warning system comprise flashing brake lights.

Embodiment 28. The method according to any of embodiments 1-27, wherein the flashing lights of the external warning system comprise flashing turn signal lights.

Embodiment 29. The method according to any of embodiments 1-28, wherein the flashing lights of the external warning system comprise flashing dedicated external warning system lights.

Embodiment 30. The method according to any of embodiments 1-29, wherein the external warning system further comprises activating a horn of the host vehicle.

Embodiment 31. The method according to any of embodiments 1-30, wherein the first predetermined threshold is 13 seconds.

Embodiment 32. The method according to any of embodiments 1-30, wherein the first predetermined threshold is 12 seconds.

Embodiment 33. The method according to any of embodiments 1-30, wherein the first predetermined threshold is 11 seconds.

Embodiment 34. The method according to any of embodiments 1-30, wherein the first predetermined threshold is 10 seconds.

Embodiment 35. The method according to any of embodiments 1-30, wherein the first predetermined threshold is 14 seconds.

Embodiment 36. The method according to any of embodiments 1-30, wherein the first predetermined threshold is 15 seconds.

Embodiment 37. The method according to any of embodiments 2-36, wherein the second predetermined threshold is 2 seconds.

Embodiment 38. The method according to any of embodiments 2-36, wherein the second predetermined threshold is 1 second.

Embodiment 39. The method according to any of embodiments 2-36, wherein the second predetermined threshold is 3 seconds.

Embodiment 40. The method according to any of embodiments 2-36, wherein the second predetermined threshold is 4 seconds.

Embodiment 41. The method according to any of embodiments 2-36, wherein the second predetermined threshold is 5 seconds.

Embodiment 42. The method according to any of embodiments 1-41, wherein the TTC of the external vehicle is calculated based on a speed of the external vehicle, an acceleration of the external vehicle (negative acceleration is deceleration), a distance between the host vehicle and the external vehicle, a speed of the host vehicle, and/or an acceleration of the host vehicle.

Embodiment 43. The method according to any of embodiments 1-42, wherein, if it is raining outside of the host vehicle, the first predetermined threshold is increased by a predetermined amount.

Embodiment 44. The method according to any of embodiments 1-43, wherein, if it is raining outside of the host vehicle, the second predetermined threshold is increased by a predetermined amount.

Embodiment 45. The method according to any of embodiments 43-44, wherein the processor whether it is raining outside of the host vehicle based on information received from at least one rain sensor of the host vehicle and/or based on monitoring use of windshield wipers of the host vehicle.

Embodiment 46. The method according to any of embodiments 1-45, wherein the host vehicle is an electric vehicle.

Embodiment 47. The method according to any of embodiments 1-21 or 27-46, wherein a length of the rear zone is 100 meters.

Embodiment 48. The method according to any of embodiments 1-21 or 27-46, wherein a length of the rear zone is 150 meters.

Embodiment 49. The method according to any of embodiments 1-21 or 27-46, wherein a length of the rear zone is 200 meters.

Embodiment 50. The method according to any of embodiments 1-21 or 27-46, wherein a length of the rear zone is 250 meters.

Embodiment 51. The method according to any of embodiments 1-21 or 27-46, wherein a length of the rear zone is 300 meters.

Embodiment 52. A system for inhibiting rear collisions of a host vehicle, the system comprising:

at least one sensor configured to monitor a rear zone behind the host vehicle;

a processor in operable communication with the at least one sensor; and

a storage medium in operable communication with the processor and having an application stored thereon that, when executed by the processor, causes the processor to perform the method according to any of embodiments 1-51.

Embodiment 53. The system according to embodiment 52, further comprising the host vehicle.

Embodiment 54. The system according to any of embodiments 52-53, wherein the host vehicle is an electric vehicle.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A method for inhibiting rear collisions of a host vehicle, the method comprising:
i) monitoring, by at least one sensor of the host vehicle, a rear zone behind the host vehicle and determining, by a processor of the vehicle, whether an external vehicle is present in the rear zone;
ii) if an external vehicle is present in the rear zone, calculating, by the processor, a time-to-collision (TTC) of the external vehicle; and
iii) if the TTC of the external vehicle is lower than a first predetermined threshold, activating an external warning system,
wherein the external warning system comprises flashing lights on a rear exterior portion of the host vehicle.

2. The method according to claim 1, further comprising:
iv) if the TTC of the external vehicle is lower than a second predetermined threshold, which is lower than the first predetermined threshold, activating a brace sequence of the host vehicle.

3. The method according to claim 2, wherein the brace sequence comprises at least one of the following: pre-tensioning seatbelts in the host vehicle; readying airbags in the host vehicle; tilting at least one head rest forward in the host vehicle; moving at least one seat in the host vehicle; and tilting a suspension of the host vehicle to raise a back portion of the host vehicle.

4. The method according to claim 2, wherein the brace sequence is deactivated if the TTC of the external vehicle increases to the second predetermined threshold or higher,
wherein the at least one sensor continues to monitor the rear zone and the processor continuously updates the TTC of the external vehicle after the brace sequence is deactivated, and
wherein the external warning system is deactivated if the TTC of the external vehicle increases to the first predetermined threshold or higher.

5. The method according to claim 2, wherein the second predetermined threshold is 2 seconds.

6. The method according to claim 1, further comprising:
iv) if the TTC of the external vehicle is lower than a second predetermined threshold, and the TTC of the external vehicle is decreasing at a rate such that a collision with the external vehicle is determined to be unavoidable, activating a brace sequence of the host vehicle.

7. The method according to claim 6, wherein the brace sequence comprises at least one of the following: pre-tensioning seatbelts in the host vehicle; readying airbags in the host vehicle; tilting at least one head rest forward in the host vehicle; moving at least one seat in the host vehicle; and tilting a suspension of the host vehicle to raise a back portion of the host vehicle.

8. The method according to claim 6, wherein the brace sequence is deactivated if the TTC of the external vehicle increases to the second predetermined threshold or higher,
wherein the at least one sensor continues to monitor the rear zone and the processor continuously updates the TTC of the external vehicle after the brace sequence is deactivated, and
wherein the external warning system is deactivated if the TTC of the external vehicle increases to the first predetermined threshold or higher.

9. The method according to claim 6, wherein the second predetermined threshold is 2 seconds.

10. The method according to claim 1, further comprising, before step i):
determining if the host vehicle shows braking intent by engaging a brake of the host vehicle or shifting to park,
wherein the external warning system is deactivated if the TTC of the external vehicle increases to the first predetermined threshold or higher, and
wherein, if the external warning system is deactivated, the processor checks whether the host vehicle still shows braking intent and:
if so, the at least one sensor continues to monitor the rear zone; and
if not, the at least one sensor no longer monitors the rear zone.

11. The method according to claim 1, wherein the at least one sensor comprises a rear-facing radar sensor.

12. The method according to claim 11, wherein the at least one sensor further comprises at least one of the following: at least one rear-facing camera; at least one front-facing camera;
and a rear-facing lidar sensor.

13. The method according to claim 1, wherein a width of the rear zone is equal to a width of a lane in which the host vehicle is traveling, and
wherein a length of the rear zone is at least 150 meters.

14. The method according to claim 1, wherein the flashing lights of the external warning system comprise at least one of the following: flashing brake lights; flashing turn signal lights; and flashing dedicated external warning system lights.

15. The method according to claim 1, wherein the first predetermined threshold is 13 seconds.

16. The method according to claim 1, wherein the TTC of the external vehicle is calculated based on a speed of the external vehicle, an acceleration of the external vehicle, a distance between the host vehicle and the external vehicle, a speed of the host vehicle, and an acceleration of the host vehicle.

17. The method according to claim 1, wherein, if it is raining outside of the host vehicle, the first predetermined threshold is increased by a first predetermined amount and the second predetermined threshold is increased by a second predetermined amount.

18. The method according to claim 1, further comprising, if the TTC of the external vehicle is lower than a second predetermined threshold, which is lower than the first predetermined threshold, activating a brace sequence of the host vehicle,
wherein the brace sequence comprises all of the following: pre-tensioning seatbelts in the host vehicle; readying airbags in the host vehicle; tilting at least one head rest forward in the host vehicle; moving at least one seat in the host vehicle; and tilting a suspension of the host vehicle to raise a back portion of the host vehicle,
wherein the brace sequence is deactivated if the TTC of the external vehicle increases to the second predetermined threshold or higher,
wherein the at least one sensor continues to monitor the rear zone and the processor continuously updates the TTC of the external vehicle after the brace sequence is deactivated,
wherein the external warning system is deactivated if the TTC of the external vehicle increases to the first predetermined threshold or higher,
wherein the second predetermined threshold is 2 seconds,
wherein the first predetermined threshold is 13 seconds,
wherein the method further comprises, before step i), determining if the host vehicle shows braking intent by engaging a brake of the host vehicle or shifting to park,
wherein the external warning system is deactivated if the TTC of the external vehicle increases to the first predetermined threshold or higher,
wherein, if the external warning system is deactivated, the processor checks whether the host vehicle still shows braking intent and:
if so, the at least one sensor continues to monitor the rear zone; and
if not, the at least one sensor no longer monitors the rear zone,
wherein the at least one sensor comprises a rear-facing radar sensor,
wherein the at least one sensor further comprises at least one of the following: at least one rear-facing camera; at least one front-facing camera; and a rear-facing lidar sensor,
wherein a width of the rear zone is equal to a width of a lane in which the host vehicle is traveling,
wherein a length of the rear zone is at least 150 meters,
wherein the flashing lights of the external warning system comprise at least one of the following: flashing brake lights; flashing turn signal lights; and flashing dedicated external warning system lights,
wherein the TTC of the external vehicle is calculated based on a speed of the external vehicle, an acceleration of the external vehicle, a distance between the host vehicle and the external vehicle, a speed of the host vehicle, and an acceleration of the host vehicle, and
wherein, if it is raining outside of the host vehicle, the first predetermined threshold is increased by a first predetermined amount and the second predetermined threshold is increased by a second predetermined amount.

19. A system for inhibiting rear collisions of a host vehicle, the system comprising:
at least one sensor configured to monitor a rear zone behind the host vehicle;
a processor in operable communication with the at least one sensor; and
a storage medium in operable communication with the processor and having an application stored thereon that, when executed by the processor, causes the processor to:
receive, from the at least sensor, data about a rear zone behind the host vehicle;
determine whether an external vehicle is present in the rear zone;
if an external vehicle is present in the rear zone, calculate a time-to-collision (TTC) of the external vehicle; and
if the TTC of the external vehicle is lower than a first predetermined threshold, activate an external warning system,
wherein the external warning system comprises flashing lights on a rear exterior portion of the host vehicle.

20. The system according to claim 19, further comprising the host vehicle,
wherein when the application is executed by the processor, if the TTC of the external vehicle is lower than a second predetermined threshold, which is lower than the first predetermined threshold, the processor further activates a brace sequence of the host vehicle,
wherein the brace sequence comprises at least one of the following: pre-tensioning seatbelts in the host vehicle; readying airbags in the host vehicle; tilting at least one head rest forward in the host vehicle; moving at least one seat in the host vehicle; and tilting a suspension of the host vehicle to raise a back portion of the host vehicle,
wherein the brace sequence is deactivated if the TTC of the external vehicle increases to the second predetermined threshold or higher,
wherein the at least one sensor continues to monitor the rear zone and the processor continuously updates the TTC of the external vehicle after the brace sequence is deactivated,
wherein the external warning system is deactivated if the TTC of the external vehicle increases to the first predetermined threshold or higher,
wherein the second predetermined threshold is 2 seconds,
wherein the first predetermined threshold is 13 seconds,
wherein when the application is executed by the processor, before receiving data from the sensor, the processor determines if the host vehicle shows braking intent by engaging a brake of the host vehicle or shifting to park,
wherein the external warning system is deactivated if the TTC of the external vehicle increases to the first predetermined threshold or higher,
wherein, if the external warning system is deactivated, the processor checks whether the host vehicle still shows braking intent and:
if so, the at least one sensor continues to monitor the rear zone; and
if not, the at least one sensor no longer monitors the rear zone,
wherein the at least one sensor comprises a rear-facing radar sensor,
wherein the at least one sensor further comprises at least one of the following: at least one rear-facing camera; at least one front-facing camera; and a rear-facing lidar sensor,
wherein a width of the rear zone is equal to a width of a lane in which the host vehicle is traveling,
wherein a length of the rear zone is at least 150 meters,
wherein the flashing lights of the external warning system comprise at least one of the following: flashing brake lights; flashing turn signal lights; and flashing dedicated external warning system lights,
wherein the TTC of the external vehicle is calculated based on a speed of the external vehicle, an acceleration of the external vehicle, a distance between the host vehicle and the external vehicle, a speed of the host vehicle, and an acceleration of the host vehicle, and
wherein, if it is raining outside of the host vehicle, the first predetermined threshold is increased by a first predetermined amount and the second predetermined threshold is increased by a second predetermined amount.
